(19) United States
(12) Patent Application Publication
(10) Pub. No.: US 2013/0093836 A1
(43) Pub. Date: Apr. 18, 2013

(54) MANAGING COMPONENTS FOR USE IN VIDEOCONFERENCES

(71) Applicants: Lori A. Cook, Corvallis, OR (US); Mark M. Miller, Albany, OR (US)

(72) Inventors: Lori A. Cook, Corvallis, OR (US); Mark M. Miller, Albany, OR (US)

(21) Appl. No.: 13/275,043

(22) Filed: Oct. 17, 2011

(51) Int. Cl. H04N 7/15

(52) U.S. Cl. 348/14.08; 348/E07.083

(57) ABSTRACT

In a method for managing a plurality of components for use in videoconferences, information about the plurality of components is received from a component manager associated with the plurality of components, wherein the information comprises component-specific and environmental information about the components. In addition, configurations for the components are determined based upon the received information.

### BACKGROUND

Modern technology has enabled traditional meetings to be replaced, partially replaced, or enhanced by some form of a technology-assisted meeting or virtual meeting. One manner of availing virtual meetings is a videoconference solution, which may allow participants to receive stimuli that makes them feel as if they are in the presence of other users during virtual meetings. In this regard, for instance, videoconference solutions may include life size video images of the other participants as well as similarities in the appearances of the separate rooms or studios from which the participants conduct the virtual meetings.

### BRIEF DESCRIPTION OF THE DRAWINGS

Features of the present disclosure are illustrated by way of example and not limited in the following figure(s), in which like numerals indicate like elements, in which:

FIG. 1 shows a block diagram of a component management system, according to an example of the present disclosure;

FIG. 2 depicts a block diagram of the component management system depicted in FIG. 1, according to another example of the present disclosure;

FIG. 3 depicts a flow diagram of a method for managing a plurality of components for use in videoconferences, according to an example of the present disclosure; and

FIG. 4 illustrates a schematic representation of a computing device, which may be employed to perform various functions of the computing device depicted in FIG. 1, according to an example of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on.

Disclosed herein are a method, apparatus, and computer readable storage medium for managing a plurality of components for use in videoconferences. The managing of the components, in one regard, is to determine configurations for the components that substantially optimize utilizations of the components. According to an example, the utilization of the components is substantially optimized when the components enable predetermined conditions to be provided during videoconferences while remaining within functional limitations of the components. Thus, for instance, configurations for the components that make it appear to the participants of a virtual meeting that they are in the same setting, such as, a room, a studio, or other location, may be determined through implementation of the method, apparatus, and computer readable storage medium disclosed herein. The types of configurations of the components that make it appear to remote participants that they are in the same setting may comprise brightness settings on the displays that substantially match illumination conditions in each of the locations, decibel levels on speakers that are matched to distances between the displays and the participants in a particular location, matching of microphones in one part of a first location with the correct speaker in another location, etc.

As discussed in greater detail herein below, information about the components in one location is received from a component manager associated with the components in that location and that information is used to determine the configurations for the components. In this regard, the computing device disclosed herein need not be programmed or hard coded with specific information regarding the components. In addition, the computing device need not be programmed or hard coded with specific information about the physical characteristics of the components, such as, their locations, their orientations, etc., with respect to each other. Instead, files containing information about the studios may be generated and the computing device may receive those files as needed to configure the components. In this regard, the computing device need not be modified each time the components are set up or existing components are upgraded or otherwise changed.

According to a particular example, the components and the component manager are contained in a videoconferencing studio, which may also be referred to as a telepresence studio, videoconferencing room, etc. In this example, the components may comprise video cameras, speakers, monitors, air conditioning systems, telephone systems, etc., and the component manager may be implemented in a server or other computing device that is in communication with these components and with an external network. In this regard, support personnel for the videoconferencing studio, who may be located remotely from the videoconferencing studio, may remotely access the components through the component manager to determine the configurations for the components. In another example, the component manager may be externally located with respect to the videoconferencing studio.

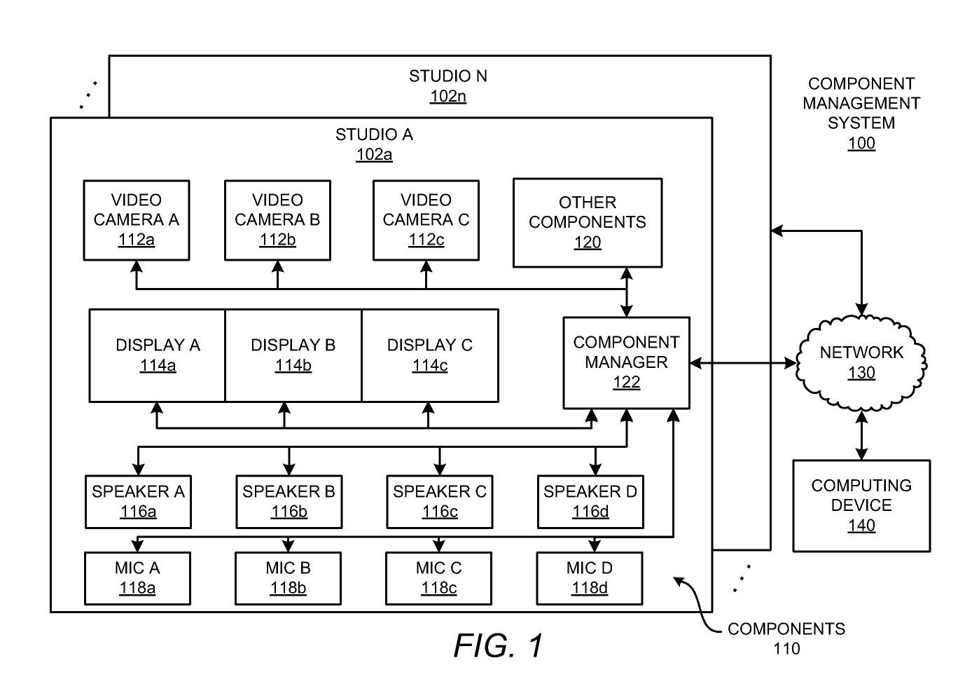

FIG. 1 is a block diagram of a component management system 100 according to an example of the present disclosure. As depicted in FIG. 1, the component management system 100 includes a plurality of studios 102a-102n and a computing device 140. The studios 102a-102n may comprise fixed locations, for instance, particular rooms and buildings, or may comprise mobile sets of components to perform videoconferencing operations. A studio 102a is depicted as including a plurality of components 110 and a component manager 122. It should be understood that the component management system 100 depicted in FIG. 1 may include additional elements and that some of the elements described herein may be removed and/or modified without departing from a scope of the component management system 100. As such, the component management system 100 may include any number of studios 102a-102n, computing devices 140, etc. In addition, each of the studios 102b-102n may comprise the same or similar configurations as the studio 102a. Moreover, although the components 110 have been depicted as including particular numbers of various elements, it should be understood that the studios 102a-102n may include any number of various types of elements without departing from a scope of the studio management system 100.

Each of the studios 102a-102n generally comprises a platform in which the components 110 co-exist together in a collaborative environment to enable videoconferences to be performed between the studios 102a-102n. In addition, the studios 102a-102n may be configured similarly with respect to each other to make each of the studios 102a-102n appear and function similarly with respect to each other. Thus, for instance, the furniture, fixtures, and the components 110 in each of the studios 102a-102n may be selected and arranged to be nearly identical to each other. In this regard, when a participant in one of the studios 102a conducts a videoconferencing session with another participant in another one of the studios 102b, the participants appear to each other as being in the same location.

In order for the participants to fully appreciate this immersive experience, the components 110 in the studios 102a-102n are also configured or otherwise set-up to attain predetermined conditions with respect to each other. For instance, cameras in one of the studios 102a may be set up to capture images at the appropriate angles to cause the participants in one studio 102a to be displayed at the correct size and angle on the displays of another studio 102b. In other words, for instance, the cameras in one of the studios 102a may be positioned to capture a participant, such that the participant appears life-sized on the appropriate display in the other studio 102b. The displays in the studios 102a-102n may also be configured, for instance, to have the appropriate settings to cause images to be displayed consistently among the displays. As another example, the microphones in the studios 120a-102n may be appropriately set up to enable sound captured by the microphones to be properly outputted from the appropriate speakers in other studios 102a-102n and at the appropriate volumes. That is, for instance, the output from microphones in a first studio 102a may be properly outputted to the appropriate speakers in a second studio 102b by matching the outputs of the microphones to the speakers associated with the correct displays from which the participants that are speaking into the microphones are displayed.

As described in greater detail herein below, the configurations of the components 110 may automatically be determined to provide, for instance, substantially optimal utilization of the components 110 contained in the studios 102a-102n. In one example, a substantially optimal utilization includes utilizing the components 110 to provide videoconferencing experiences to participants in the studios 102a-102n that make it appear and feel as if each of the participants located in different studios 102a-102n are in the same location. These experiences may be provided when the components 110 are set up to provide substantially similar inputs and outputs in each of the studios 102a-102n. This may involve, for instance, setting the lighting conditions in each of the studios 102a-102n to be the same, setting the focal points of the video cameras to cause the objects and the participants in the studios 102a-102n to appear at their appropriate sizes on the displays in other ones of the studios 102a-102n, setting the microphones and the speakers to respectively capture and output sound at the appropriate decibel levels and locations, etc.

As shown in FIG. 1, the studio 102a is depicted as including a number of different components 110. The components 110 have been depicted as including video cameras 112a-112c, displays 114a-114c, speakers 116a-116d, microphones (MICs) 118a-118d, and other components 120. The other components 120 may include, for instance, lighting devices, environmental control devices, computing devices, switches, software, etc. The components 110 may also comprise elements other than physical electronic devices. For instance, the components 110 may comprise modules of machine-readable instructions stored on at least one electronic device.

The studio 102a is also depicted as including a component manager 122 in communication with each of the components 110. The component manager 122 may be in communication with the components 110 through any suitable type of connection. For instance, the component manager 122 may be wired to the components 110 directly and/or indirectly through various interfaces (not shown). In addition, or alternatively, the component manager 122 may communicate with the components 110 wirelessly through, for instance, Wi-Fi, Bluetooth™, etc.

The component manager 122 may comprise, for instance, a server or other computing device comprising logic, hardware and/or software, to perform various functions with respect to the components 110 contained in the studio 102a. The component manager 122 may also comprise a set of machine readable instructions stored on a memory or an integrated chip programmed to perform the various functions in the studio 102a. In the latter example, the component manager 122 may be stored in a server or other computing device and may be implemented by a processor (e.g., CPU) of the server or other computing device. In addition, the component manager 122 may be located outside of the studio 102a.

The component manager 122 is to collect signals and/or information from the components 110 for purposes of configuring the components 110. Thus, for instance, the component manager 122 is to communicate the collected signals and/or information to the computing device 140 over the network 130. In addition, or alternatively, the component manager 122 is to access information about each of the components 110 and to communicate that information to the computing device 140 over the network 130. The information about each of the components 110 may be contained in at least one configuration file. Moreover, the at least one configuration file may be stored locally with the component manager 122 or may be stored remotely from the component manager 122. In any regard, the component manager 122 may access and communicate the at least one configuration file to the computing device 140 over the network 130.

A user or technician may generate the configuration files for each of the components 110. This may include determining information pertaining to the capabilities or functionalities of the components 110 as well as determining the physical locations of the components 110 in the studio 102a and inserting that information into the configuration files. The user or technician may generate the configuration files, for instance, when the studio 102a is initially set up, following changes to the studio 102a, such as an upgrade, etc. In addition, the user or technician may generate the configuration files from information gathered from the manufacturers of the components 110, from testing out the components 110, etc. The configuration files may therefore contain various information pertaining to the components 110. For instance, for the displays 114a-114c in a particular studio 102a, the configuration file may contain information pertaining to the manufacturers, the brightness ranges, the contrast ratios, the maximum resolutions, the locations of each of the displays 114a-114c, etc. As another example, for the video cameras 112a-112c in a studio 102a, the configuration file may contain information pertaining to the manufacturers, the zoom ranges, the resolutions, the angles at which the video cameras 112a-112c are positioned, the locations of each of video carmers 112a-112c, etc.

The network 130 may comprise the Internet, an intranet, a Local Area Network (LAN), a telecommunications network, etc. In this regard, the studios 102a-102n may be located in geographically different locations with respect to each other and may communicate data between each other over the network 130. In addition, the studios 102a-102n may be located in geographically different locations with respect to the computing device 140 and may communicate data with the computing device 140 over the network 130. Thus, for instance, the computing device 140 may be located at a help center for the studios 102a-102n in one part of the world, while the studios 102a-102n are located in various other parts of the world.

Although FIG. 1 has been depicted as including a single component manager 122, it should be understood that the studios 102a-102n may include a plurality of component managers 122 or other devices that manage groups of the components 110. Thus, for instance, a particular component manager 122 or other device may control all of the speakers 116a-116d and another component manager 122 or other device may manage all of the microphones 118a-118d, etc.

According to an example, the component manager 122 collects signals from the components 110 and/or communicates signals to the components 110. Thus, for instance, the component manager 122 collects signals pertaining to images captured by the video cameras 112a-112c in studio A 102a and communicates those images to the component manager 122 in another studio B 102b over a network 130 during a videoconference session. In this regard, the component manager 122 may add tags or other information onto the signals to indicate, for instance, the type of signal being communicated and from which input device (e.g., microphone, video camera, computing device, etc.), the signals were inputted. Likewise, for instance, the component manager 122 in the studio A 102a may receive signals from another component manager 122 in another studio B 102b and may cause those signals to be outputted through the appropriate components 110 (e.g., display, speaker, computing device, etc.). Thus, by way of example, the component manager 122 may receive video and audio signals from the component manager 122 in another studio B 102b and may control the display of the video on the appropriate display 114a and the audio output through the appropriate speaker(s) 116a, 116b. That is, for instance, the component manager 122 may control the display 114a and the speaker 116a to output corresponding signals such that the audio and the video being outputted match each other. In one example, the received signals may comprise data packets that the component manager 122 may process to determine the appropriate output components 110 for the signals in the studio 102a.

In another example, a separate manager in the studios 102a-102n may perform the various functions described in the previous paragraph.

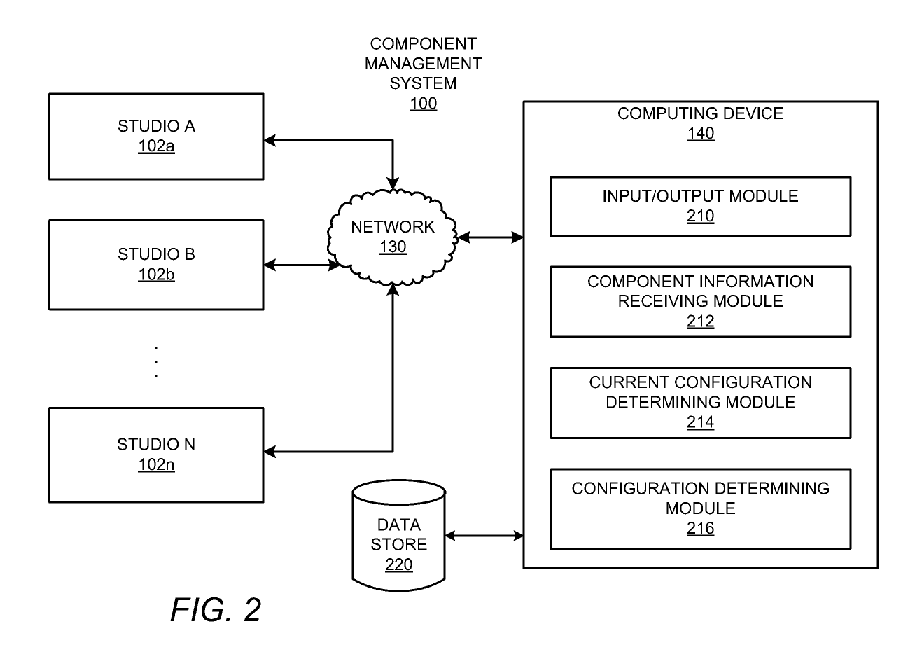

Turning now to FIG. 2, there is shown a block diagram of the component management system 100 depicted in FIG. 1, according to another example of the present disclosure. More particularly, FIG. 2 depicts the component management system 100 of FIG. 1, but with a more detailed depiction of the computing device 140 and a less detailed depiction of the studios 102a-102n. It should be understood that the component management system 100 depicted in FIG. 2 may include additional elements and that some of the elements described herein may be removed and/or modified without departing from a scope of the component management system 100.

As shown in FIG. 2, the computing device 140 comprises an input/output module 210, a component information receiving module 212, a current configuration determining module 214, and a configuration determining module 216. The computing device 140 is also depicted as communicating with a data store 220 that may store, for instance, information received from the component managers 122, information pertaining to predetermined conditions to be attained in the studios 102a-102n, etc. According to an example, the computing device 140 comprises a server or other computing device and thus includes a central processing unit (CPU) (not shown).

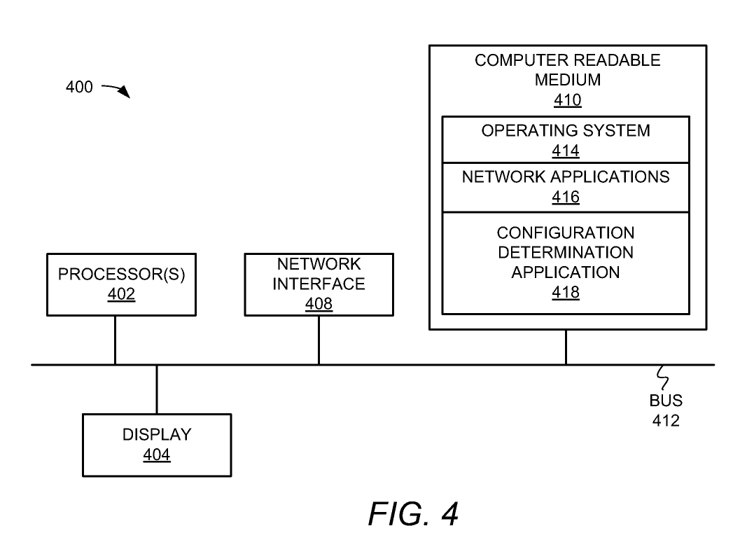

In any regard, the modules 210-216 comprises at least one software module and/or at least one hardware module. The modules 210-216 may thus comprise machine-readable instructions that may be stored, for instance, in a volatile or non-volatile memory, such as DRAM, EEPROM, MRAM, flash memory, floppy disk, a CD-ROM, a DVD-ROM, or other optical or magnetic media, and the like, and executable by a processor of a computing device, for instance, as depicted in FIG. 4. According to another example, the modules 210-216 comprise at least one hardware device, such as, a circuit or multiple circuits arranged on a printed circuit board. According to a further example, the modules 210-216 comprise a combination of machine-readable instructions and hardware modules.

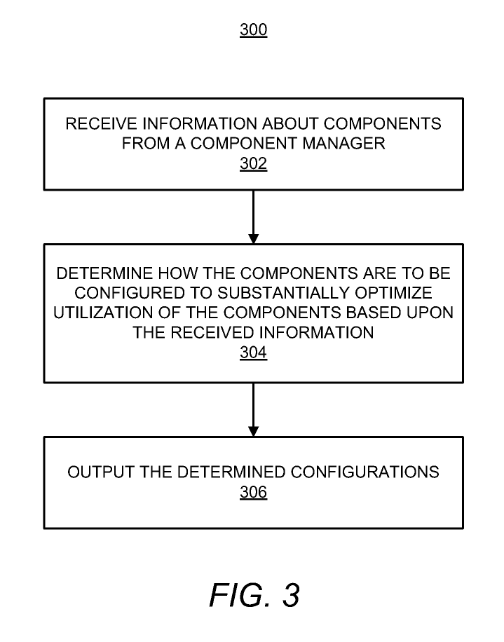

Various manners in which the modules 210-216 may be implemented are described in greater detail below with respect to the method 300 depicted in FIG. 3. FIG. 3, more particularly, shows a flow diagram of a method 300 for managing a plurality of components 110 for use in video conferences depicted in FIG. 1, according to an example. It should be readily apparent that the method 300 depicted in FIG. 3 represents a generalized illustration and that other processes may be added or existing processes may be removed, modified or rearranged without departing from the scope of the method 300.

Generally speaking, the computing device 140, and more particularly, the modules 210-216 of the computing device 140, are to implement the method 300. In one example, the computing device 140 is to implement the method 300 in response to receipt of a request by a user for a configuration determination of the components 110. Thus, for instance, the user may request for the configuration determination when the components are initially set up, when a new component is installed, when a software and/or firmware update is made, etc.

In one regard, the computing device 140 need not be programmed or hard coded with specific information regarding the components 110 contained in the studios 102a-102n. In addition, the computing device 140 need not be programmed or hard coded with specific information about the environmental aspects of the components 110, such as, their locations, their orientations, etc., within the studios 102a-120n. Instead, files containing information about the studios 102a-102n may be generated and the computing device 140 may receive those files as needed to configure the components 110. As such, the computing device may not contain information regarding the components 110 or their environmental aspects prior to receipt of the information from a component manager 122.

At block 302, information about the components 110 is received from a component manager 122, for instance, by the component information receiving module 212. As discussed above, the computing device 140 is to communicate with the component managers 122 associated with the components 110 through the network 130. In any regard, the received information generally comprises component-specific and environmental information about the components 110.

The component-specific information may comprise information pertaining to individual ones of the components 110. For instance, the component-specific information may identify each of the components 110 contained in the studio 102a, the manufacturers of each of the components 110, the individual functionalities of the components 110, etc. The functionalities of the components 110 may include the capabilities of the components. Thus, by way of example, the component-specific information may identify that a first one of the displays 114a is from a first manufacturer and that a second one of the displays 114b is from a second manufacturer. In this example, the component-specific information may also identify that the first display 114a is able to reach certain contrast ratios that differ from the second display 114b. As a further example, information pertaining to the functionalities of the components 110 may include whether the components 110 are attached to or otherwise maneuverable through electronically controlled actuators.

The environmental information about the components may comprise information pertaining to physical characteristics of the components 110 in the studio 102a. The physical characteristics of the components 110 may comprise the positioning of the components 110 in the studio 102a, the orientations of the components 110, the number of various types of components 110 provided in the studio 102a, etc. Thus, by way of example, the environmental information may indicate that there are seven speakers evenly spaced across a particular wall of the studio 102a. As another example, the environmental information may indicate that there are a particular number of cameras directed to capture images from particular sections of the studio 102a.

At block 304, configurations for the components 110 in the studio are determined based upon the received information, in which the configurations are to substantially optimize utilization of the components 110, for instance, by the configuration determining module 216. According to an example, the configuration determining module 216 may determine the configurations for the components 110 that result in predetermined conditions being attained in the studio 102a, while remaining within the functionalities of the components 110. The predetermined conditions may include, for instance, predetermined lighting conditions, predetermined volume levels of the speakers 116a-116d, predetermined display outputs of the displays 114a-114c, etc., that result in the participants in the different studios 102a-102n receiving stimuli that make them feel as if they are in the presence of other participants in other studios 102a-102n. In this regard, the configuration determining module 216 may determine, based upon the component-specific and the environmental information, how each of the components 110 is to be configured to substantially attain the predetermined conditions. In certain instances, some of the components 110 may be unable to be configured as determined by the configuration determining module 216. In these instances, configurations for the components 110 in that most closely meet the determined configuration may be used as the determined configurations.

The configurations for the components may be determined by determining at least one of values to use to set up the components, limits of the values, expected values of the components, what aspects of the studio environment affect the values used to set up the components, what aspects of the studio environment affect which of the components, etc. In this regard, values for the configurations for the components 110 may be determined based upon at least one of the placements of the components 110, the numbers of the components 110 present, etc. The values may also be limited by the respective functionalities of the components 110.

According to an example, the studio 102a may be equipped with different types of displays 114a-114c, such as displays from different manufacturers, that have different capabilities or functionalities. In this example, the configuration determining module 216 may determine how each of the different displays 114a-114n is to be configured to substantially attain the predetermined display outputs, such as, contrast levels, hue settings, etc. In other words, the configuration determining module 216 may determine how each of the different displays 114a-114n is to be configured to enable the displays to provide a consistent video conferencing experience regardless of the locations of the participants.

According to another example, the computing device 140 may determine how the configurations of the components 110 are to be modified from their current configurations. In this example, the current configurations of the components 110 may be determined, for instance, by the current configuration determining module 214. More particularly, for instance, the current configurations of the components 110 may be determined and the component manager 122 may communicate the current configuration information to the current configuration determining module 214. The current configurations of the components 110 may be determined in various manners. For instance, a user or a technician in the studio 102a may manually determine the settings of the components 110 and may enter those settings into the component manager 122. As another example, the computing device 140 may query the components 110 for their current configurations and may automatically receive the current configuration information from the components 110 over the network 130.

According to a particular example, a technician in the studio 102a may test the components 110 to determine the current configurations. In this example, the technician may test the components 110 and the information obtained through the testing may be used to determine the current component 110 values and how close the values are to the nominal values for the components 110, for instance, as defined in the configuration files of the components 110. Thus, for instance, the technician may move a sound box around or position it strategically in the studio 102a to test the microphones 118a-118d in the studio 102a. As another example, the technician may move a color chart around the studio 102 such that the video cameras 112a-112c are able to capture images of the color chart. The current configuration determining module 214 may use the information obtained from this testing to determine the current configurations of the components 110.

At block 306, the determined configurations for the components 110 are outputted, for instance, by the input/output module 210. The input/output module 210 may output data including the determined configurations over the network 130 to a technician in the studio 102a, who may implement the determined configurations. In addition, or alternatively, the input/output module 210 may output control signals to at least one of the components 110 to remotely change the configuration of the at least one of the components 110 as determined by the configuration determining module 216. Moreover, the determined configurations for the components 110 may be stored, for instance, in the data store 220, such that a determination as to whether any of the values of the configurations has changed may be made. In another example, the configurations determined over a number of iterations of the method 300 may be used to determine a substantially optimal configuration for the components 110. That is, for instance, various configurations may be implemented and the configuration that yields the substantially optimal conditions in the studio 102a may be determined as being the substantially optimal configuration for the components 110.

Some or all of the operations set forth in the method 300 may be contained as a utility, program, or subprogram, in any desired computer accessible medium. In addition, the method 300 may be embodied by computer programs, which may exist in a variety of forms both active and inactive. For example, they may exist as machine-readable instructions, including source code, object code, executable code or other formats. Any of the above may be embodied on a computer readable storage medium.

Examples of computer readable storage media include conventional computer system RAM, ROM, EPROM, EEPROM, and magnetic or optical disks or tapes. Concrete examples of the foregoing include distribution of the programs on a CD ROM or via Internet download. It is therefore to be understood that any electronic device capable of executing the above-described functions may perform those functions enumerated above.

Turning now to FIG. 4, there is shown a schematic representation of a computing device 400, which may be employed to perform various functions of the computing device 140 depicted in FIG. 1, according to an example. The device 400 includes a processor 402, a display device 404, such as a monitor; a network interface 408, such as a Local Area Network LAN, a wireless 802.11x LAN, a 3G mobile WAN or a WiMax WAN; and a computer-readable medium 410. Each of these components is operatively coupled to a bus 412. For example, the bus 412 may be an EISA, a PCI, a USB, a FireWire, a NuBus, or a PDS.

The computer readable medium 410 may be any suitable non-transitory medium that participates in providing instructions to the processor 502 for execution. For example, the computer readable medium 410 may be non-volatile media, such as an optical or a magnetic disk; volatile media, such as memory; and transmission media, such as coaxial cables, copper wire, and fiber optics. The computer readable medium 410 may also store other machine-readable instructions, including word processors, browsers, email, Instant Messaging, media players, and telephony machine-readable instructions.

The computer-readable medium 410 may also store an operating system 414, such as Mac OS, MS Windows, Unix, or Linux; network applications 416; and a configuration determination application 418. The operating system 414 may be multi-user, multiprocessing, multitasking, multithreading, real-time and the like. The operating system 414 may also perform basic tasks such as recognizing input from input devices, such as a keyboard or a keypad; sending output to the display 404; keeping track of files and directories on the computer readable medium 410; controlling peripheral devices, such as disk drives, printers, image capture device; and managing traffic on the bus 412. The network applications 416 include various components for establishing and maintaining network connections, such as machine-readable instructions for implementing communication protocols including TCP/IP, HTTP, Ethernet, USB, and FireWire.

The configuration determination application 418 provides various components for managing a plurality of components 110 as described above with respect to the method 300 in FIG. 3. The configuration determination application 418 may thus be comprised in the computing device 140 and, when implemented, determines configurations for the components 110 that substantially optimize utilization of the components in the studio 102a based upon information received about the components 110 from a component manager 122 of the studio 102a. In certain examples, some or all of the processes performed by the application 418 may be integrated into the operating system 414. In certain examples, the processes may be at least partially implemented in digital electronic circuitry, or in computer hardware, machine-readable instructions (including firmware and/or software), or in any combination thereof.

Although described specifically throughout the entirety of the instant disclosure, representative embodiments of the present disclosure have utility over a wide range of applications, and the above discussion is not intended and should not be construed to be limiting, but is offered as an illustrative discussion of aspects of the disclosure.

What has been described and illustrated herein is a preferred example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. A method for managing a plurality of components for use in videoconferences, said method comprising:
receiving information about the plurality of components from a component manager associated with the plurality of components, wherein the information comprises component-specific and environmental information about the components; and
determining, by a processor, configurations for the components based upon the received information.

2. The method according to claim 1, wherein the component-specific information comprises information pertaining to functionalities of the components, wherein the environmental information about the components comprises information pertaining to physical characteristics of the components, and wherein determining the configurations for the components further comprises determining configurations for the components that substantially enable predetermined conditions to be provided during videoconferences while remaining within the functionalities of the components.

3. The method according to claim 1, wherein receiving the information from the component manager further comprises receiving the information about the components from the component manager remotely over a network connection.

4. The method according to claim 1, further comprising:
determining current configurations of the components; and
wherein determining configurations for the components further comprises determining the configurations as deviations from the current configurations.

5. The method according to claim 4, wherein determining the current configurations of the components further comprises communicating a request to the components for the current configurations and receiving data from the components containing information pertaining to the current configurations.

6. The method according to claim 4, wherein determining the current configurations of the components further comprises testing of the components to determine the current configurations.

7. The method according to claim 1, wherein the components comprise equipment for enabling videoconferences to be conducted in a videoconferencing location, and wherein determining configurations for the components further comprises determining configurations for the components that substantially optimize utilization of the components to provide a consistent videoconferencing experience regardless of which location of a plurality of locations a plurality of participants are located.

8. The method according to claim 1, further comprising:
outputting at least one of the determined configurations for the components and an instruction signal corresponding to the determined configurations for the components.

9. The method according to claim 1, wherein determining the configurations further comprises determining configurations for the components that substantially optimize utilization of the components in videoconferences.

10. The method according to claim 1, wherein the plurality of components comprises a plurality of displays, wherein the component-specific information about the plurality of displays comprises at least one of manufacturers, brightness ranges, contrast ratios, and maximum resolutions of the plurality of displays, and wherein the environmental information about the plurality of displays comprises the locations of the plurality of displays with respect to each other.

11. The method according to claim 10, wherein determining configurations for the components further comprises determining configurations for the plurality of displays that causes the displays to output video having similar visual characteristics with respect to each other.

12. A computing device for managing a plurality of components for use in videoconferences, said computing device comprising:
a module to receive information about the plurality of components from a component manager associated with the plurality of components, wherein the information comprises component-specific and environmental information about the components, to determine configurations for the components based upon the received information that substantially optimize utilization of the components in videoconferences, and to output the determined configurations for the components; and
a processor to implement the module.

13. The computing device according to claim 12, wherein the component-specific information comprises information pertaining to functionalities of the components and wherein the environmental information about the components comprises information pertaining to physical characteristics of the components.

14. The computing device according to claim 12, wherein the module is further to determine configurations for the components that substantially enable predetermined conditions to be provided during videoconferences while remaining within the functionalities of the components.

15. The computing device according to claim 12, wherein the module is further to determine current configurations of the components and to determine the configurations for the components as deviations from the current configurations.

16. The computing device according to claim 12, wherein the module does not contain the information about the components prior to receipt of the information from the component manager.

17. A non-transitory computer readable storage medium on which is embedded a computer program, said computer program implementing a method for managing a plurality of components for use in videoconferences, said computer program comprising computer readable code to:
receive information about the components from a component manager associated with the prodding of components, wherein the information comprises component-specific and environmental information about the components, wherein the component-specific information comprises information pertaining to functionalities of the components; and
determine configurations for the components that substantially enable predetermined conditions to be provided during videoconferences while remaining within the functionalities of the components.
